(19) United States
(12) Patent Application Publication
(10) Pub. No.: US 2011/0288913 A1
(43) Pub. Date: Nov. 24, 2011

(54) Interactive Ads

(75) Inventors: Dan Waylonis, Mt. View, CA (US); Rajat Dewan, Mt. View, CA (US)

(73) Assignee: Google Inc., Mountain View, CA (US)

(21) Appl. No.: 12/784,474

(22) Filed: May 20, 2010

(51) Int. Cl. G06Q 30/00; G06F 3/041; G06F 3/048

(52) U.S. Cl. 705/14.4; 715/764; 345/173

(57) ABSTRACT

This specification describes technologies relating to content presentation. In general, one aspect of the subject matter described in this specification can be embodied in methods that include the actions of receiving an interactive content item at a mobile device; presenting the interactive content item on the mobile device, the interactive content item being presented with other content; receiving a user input associated with the content item, the user input being one of a plurality of available user inputs associated with the content item; identifying a content item action corresponding to the received user input from among a plurality of content item actions, each associated with a different user input; and performing, using one or more processors, the identified content item action.

### BACKGROUND

The present disclosure relates to content presentation.

Advertisers provide advertisements in different forms in order to attract consumers. An advertisement (“ad”) is a piece of information designed to be used in whole or part by a user, for example, a particular consumer. Ads can be provided in electronic form. For example, online ads can be provided as banner ads on a web page, as ads presented with search results, or as ads presented in a mobile application.

One can refer to the inclusion of an ad in a medium, e.g., a webpage or a mobile application, as an impression. An advertising system can include an ad in a webpage, for example, in response to one or more keywords in a user search query input to a search engine. If a user selects the presented ad (e.g., by “clicking” the ad), the user is generally taken to another location associated with the ad, for example, to another, particular web page.

### SUMMARY

This specification describes technologies relating to content presentation.

In general, one aspect of the subject matter described in this specification can be embodied in methods that include the actions of receiving an interactive content item at a mobile device; presenting the interactive content item on the mobile device, the interactive content item being presented with other content; receiving a user input associated with the content item, the user input being one of a plurality of available user inputs associated with the content item; identifying a content item action corresponding to the received user input from among a plurality of content item actions, each associated with a different user input; and performing, using one or more processors, the identified content item action. Other embodiments of this aspect include corresponding systems, apparatus, and computer program products.

These and other embodiments can optionally include one or more of the following features. The content item is an advertisement. The method further includes associating the user input with the content item including: detecting a touch input to the mobile device display, determining a location of the touch input relative to the presented content item, and associating the user input with the content item if the location is within a specified proximity of the content item. The method further includes associating the user input with the content item including: detecting movement of the mobile device, determining whether the movement is associated with another mobile device process, and associating the user input with the content item if the movement is not associated with another mobile device process.

Identifying a content item action further includes: identifying a pattern associated with the received user input; and matching the identified pattern to a mapping of patterns to content item actions. Performing the content item action includes using embedded logic to execute one or more commands associated with the identified content item action. Performing the content item action includes expanding the content item to display additional information about the content item. Performing the content item action includes presenting an alternative content item in place of the content item. Performing the content item action includes hiding the content item from display. Performing the content item action includes presenting content item privacy options.

Particular embodiments of the subject matter described in this specification can be implemented to realize one or more of the following advantages. Presentation of content (e.g., ads) is improved by allowing users to interact with the presented content in order to provide additional functionality. Additionally, user interaction with an advertisement, can allow advertisers to reduce costs by reducing accidental ad clicks. Users of content including interactive ads can easily dismiss the ads to resume interaction with the content (e.g., an application or other content).

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram of an example content presentation system.

FIG. 2 is a block diagram of an example system for providing interactive ads.

FIG. 3 is a flow chart of an example method for performing an interactive ad action.

FIGS. 4A-4C show example ad actions made in response to received input.

Like reference symbols in the various drawings indicate like elements.

### DETAILED DESCRIPTION

Content items can be presented in a variety of context including on mobile device displays. Some content items (e.g., ads) can be included with the display of other content, for example, as part of a web page or mobile application interface. Because of the smaller screen size and the properties of mobile devices, viewing and interacting with content items can be difficult. Interactive content items are provided that execute different content item actions according to different user inputs. Thus, the behavior of the content item can change based on user input associated with the content item.

While reference will be made below to advertising systems and methods, other forms of content including other forms of sponsored content can be managed, presented, and tracked in accordance with the description below.

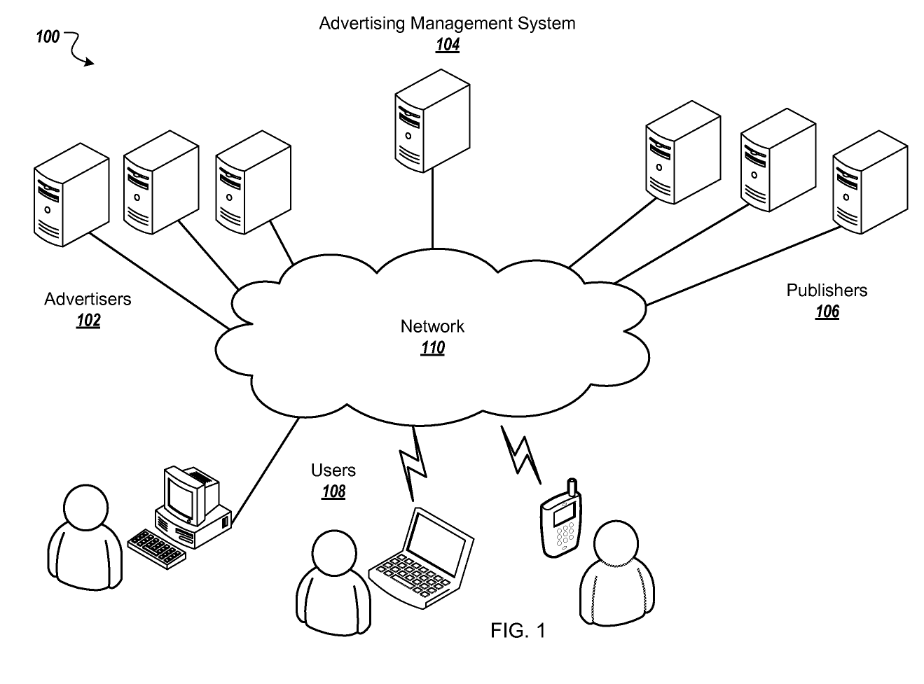

FIG. 1 is a block diagram of an example content presentation system 100. In some implementations, one or more advertisers 102 can directly, or indirectly, enter, maintain, and track ad information in an advertising management system 104. Though reference is made to advertising, other forms of content, including other forms of sponsored content, can be delivered by the system 100. The ads can be in the form of graphical ads, such as banner ads, text only ads, image ads, barcode ads, audio ads, video ads, animated ads, ads combining one or more of any of such components, etc. The ads can also include embedded information, such as links, meta-information, and/or machine executable instructions. One or more publishers 106 can submit requests for ads to the advertising management system 104. The advertising management system 104 responds by sending ads to the requesting publisher 106 for placement on or association with one or more of the publisher's content items (e.g., web properties). Example web properties can include web pages, television and radio advertising slots, or print media space.

Other entities, such as users 108 and the advertisers 102, can provide usage information to the advertising management system 104, such as, for example, whether or not a conversion (e.g., a purchase or other interaction) or a click-through related to an ad (e.g., a user has selected an ad) has occurred. This usage information can include measured or observed user behavior related to ads that have been served. The advertising management system 104 can perform financial transactions, for example, crediting the publishers 106 and charging the advertisers 102 based on the usage information.

A network 110, such as a local area network (LAN), wide area network (WAN), the Internet, one or more telephony networks or a combination thereof, connects the advertisers 102, the advertising management system 104, the publishers 106, and the users 108.

One example publisher 106 is a general content server that receives requests for content (e.g., articles, discussion threads, music, video, graphics, search results, web page listings, information feeds, etc.), and retrieves the requested content in response to the request. The content server can submit a request for ads to an advertisement server in the advertising management system 104. The ad request can include a number of ads desired. The ad request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser combines the requested content with one or more of the ads provided by the advertising management system 104. The combined content and ads can be sent/rendered to the users 108 that requested the content for presentation in a viewer (e.g., a browser or other content display system). The content server can transmit information about the ads back to the advertisement server, including information describing how, when, and/or where the ads are to be rendered (e.g., in HTML or JavaScript).

Another example publisher 106 is a search service. A search service can receive queries for search results. In response, the search service can retrieve relevant search results from an index of documents (e.g., from an index of web pages). Search results can include, for example, lists of web page titles, snippets of text extracted from those web pages, and hypertext links to those web pages, and can be grouped into a predetermined number of (e.g., ten) search results.

The search service can submit a request for ads to the advertising management system 104. The request can include a number of ads desired. This number can depend, for example, on the search results, the amount of screen or page space occupied by the search results, the size and shape of the ads, etc. The request for ads can also include the query (as entered or parsed), information based on the query (such as geo-location information, whether the query came from an affiliate and an identifier of such an affiliate), and/or information associated with, or based on, the search results. Such information can include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores are computed from, for example, dot products of feature vectors corresponding to a query and a document, page rank scores, and/or combinations of IR scores and page rank scores, etc.

In some implementations, the advertising management system 104 can use an auction process to select ads from the advertisers 102. For example, the advertisers 102 can be permitted to select, or bid, an amount the advertisers 102 are willing to pay for each presentation of or interaction with (e.g., click) of an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

The search service can combine the search results with one or more of the ads provided by the advertising management system 104. This combined information can then be forwarded to the users 108 that requested the content. The search results can be maintained as distinct from the ads, so as not to confuse the user between paid ads and presumably neutral search results.

In some implementations, one or more publishers 106 submit requests for ads to the advertising management system 104. The advertising management system 104 responds by sending ads to the requesting publisher 106 for placement on one or more of the publisher's web properties (e.g., websites and other network-distributed content) that are relevant to the web property. For example, if a publisher 106 publishes a sports-related web site, the advertising management system 104 can provide sports-related ads to the publisher 106. In some implementations, the requests can instead be executed by devices associated with the user 108, e.g., by the execution of a particular script (e.g., JavaScript) when the publisher's web page is loading on a client device.

Another example publisher 106 is a mobile application developer. A mobile application is an application specifically designed for operation on a mobile device (e.g., a smart phone). The mobile application can also include ads positioned within the content of the mobile application. Similar to publishers 106 described above, the ads can be received from the advertising management system 104 for placement in the mobile application when accessed by a user (e.g., when a particular page of a mobile application is loaded on the mobile device).

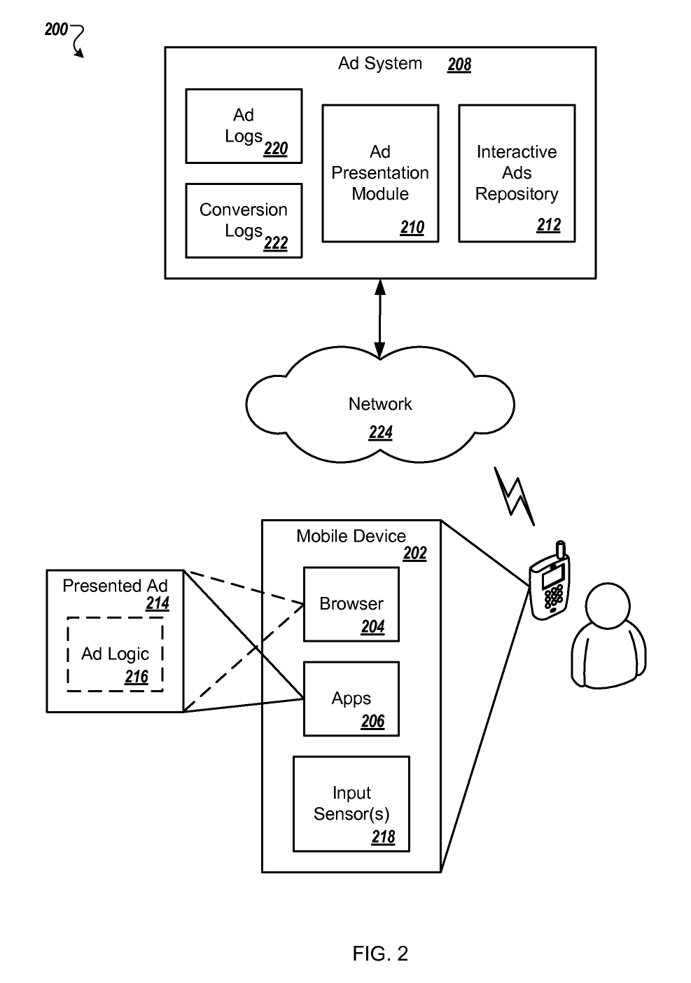

FIG. 2 is a block diagram of an example system 200 for providing interactive ads. The system 200 can provide interactive ads, for example, to a device (e.g., a mobile device) for presentation to a user. The interactive ads can include ad logic that receives and/or responds to user input according to particular ad actions associated with the user input. Ad actions can include resizing the ad, presenting an alternative ad, opening a landing page, presenting ad options, etc.

The system 200 includes a mobile device 202 that can present content to a user. In some implementations, the mobile device 202 is a cellular telephone, a personal digital assistant, a tablet PC, a vehicle navigation system, or a netbook. While the mobile device 202 is shown, in some implementations, other devices can be used, for example, a laptop, a desktop computer, an Internet kiosk, a server, or a television with a set-top box. The mobile device 202 can include, for example, a web browser 204 and one or more applications 206, e.g., news applications, email applications, games, or utilities.

The mobile device 202 can request content (e.g., a web page, search results) from one or more publishers (e.g., publishers 106). Similarly, content can be presented, and requested, using a particular application 206 on the mobile device 202. The requested content can include one or more advertisements. In some implementations, the mobile device 202 can request ads from an ad system 208. The ad system 208 can identify ads and provide them to the mobile device 202 for incorporation within presented content. In some implementations, the ad system 208 receives requests for ads from the mobile device 202 but provides the ad content to a particular publisher for integration within requested content to be provided to the mobile device 202. An ad presentation module 210 included in the ad system 208 can determine one or more ads to serve to the mobile device 202 with the requested content. The ads can include interactive ads selected from an interactive ads repository 212.

The ad presentation module 210 can identify and rank the ads stored in the interactive ads repository 212, and other ads in the ad system 208 (e.g., non-interactive ads), based on particular criteria in order to match the ads with the requested content and/or the requesting user. For example, the ad presentation module 210 can identify ads based on keywords associated with the ads that correspond with the requested content in which the ads are to be presented (e.g., matching ad keywords to keywords in requested content or query terms). In another example, the ad presentation module 210 uses information about the user (e.g., user profile information) to identify ads. In another example, the ad presentation module 210 can send a social networking application ads based on the specific application requesting the ads (e.g., the ads are for products or services that appeal to a typical user of the social networking application).

The interactive ads stored in the interactive ads repository 212 can include ad logic that allows the ad to execute commands in response to user input associated with a presented ad. For example, the ad logic can resize the respective ad, request an alternative ad for presentation, open a landing page associated with the respective ad, present ad options, or allow configuration of ad settings on the mobile device 202. Example actions performed by an interactive ad in response to input are described in greater detail below.

The mobile device 202 can present the combined content on a display. For example, a presented ad 214 can be displayed in one of the applications 206 or the web browser 204. The presented ad 214 is an interactive ad. In some implementations, the presented ad 214 is displayed with one or more additional ads on the display. The presented interactive ads can include an indicator (e.g., graphical or audible) so that a user can identify the interactive ads. For example, interactive ads can include text stating “Interactive ad” at the top of the ad.

The presented ad 214 can include ad logic 216. The ad logic 216 can receive input from one or more input sensors 218 (e.g., a touch screen of a mobile device) and execute a command in response to receiving the input. The ad logic 216 can include a mapping of user input patterns to actions associated with interactive ads. The ad logic 216 can identify a pattern associated with the received input and match an action to the pattern using the mapping. For example, the ad logic 216 and identify a gesture as a vertical swiping motion from the top to the bottom of the presented ad 214 on a touch screen user interface. The mapping of user input patterns to interactive ad actions can be the same for all of the ads stored in the interactive ads repository 212.

In one example, the input sensors 218 can receive input from the user of the mobile device 202. The mobile device 202 can determine that the received input is associated with the presented ad 214. The ad logic 216 can receive the user input from the input sensors 218 and determine a command associated with the user input (e.g., resizing the ad). The ad logic 216 can execute the determined command, e.g., by expanding the size of the presented ad 214 on the display of the mobile device 202.

The input sensors 218 can include a touch screen display, keys or a trackball on the mobile device 202, or an accelerometer or gyroscope that measure the movement or orientation of the mobile device 202 respectively. The mobile device 202 can determine whether input received from the input sensors 218 is directed to a presented interactive ad, presented content, or an application or process running on the mobile device 202.

For example, the mobile device 202 can determine that a swiping motion on a touch screen display containing a page presented in the web browser 204 is intended to scroll the web page down.

In another example, the mobile device 202 can associate touch input from the left to the right of the presented ad 214 with the ad logic 216. A touch screen input sensor can provide location information of a detected gesture on the display to the mobile device 202. The mobile device 202 can determine that the presented ad 214 was displayed on the area of the display associated with the location (e.g., within a specified region with respect to the ad location) and provide the detected gesture to the ad logic 216.

The ad logic 216 can map the input to patterns in order to identify the action associated with the left to right swipe, e.g., present an alternative ad on the display. In the example of an alternative ad, the alternative ad can be pre-fetched with the presented ad 214, identified by the presented ad 214 (e.g., the presented ad 214 can include an identifier of the alternative ad), or requested by the ad logic 216 in response to identifying that the input indicates a request that an alternative ad be displayed.

In some implementations, the input sensors 218 can detect multiple inputs at the same time. For example, the input sensors 218 can detect selection of two keys at the same time or multiple concurrent touch inputs to a touch screen. The input sensors 218 can send key stroke combinations, touch gesture combinations, or other combined input patterns to the ad logic 216.

The ad system 208 can track ads presented on the mobile device 202 in one or more ad logs 220. Each record in the ad logs 220 can include, for example, an ad identifier, an identifier for the user (e.g., a user identifier, profile identifier, device identifier), and/or a time stamp for each particular presentation of the ad on the mobile device 202. In some implementations, the mobile device 202 can send the user identifier to the ad system 208 along with the content request. The ad logs 220 can track presentation of interactive ads, non-interactive, or both.

Ad conversion information for the ads presented on the mobile device 202 can be stored in one or more conversion logs 222 on the ad system 208. When the ad system 208 detects an ad conversion on the mobile device 202, the ad system 208 can create or update a record in the conversion logs 222. The conversion logs 222 can include, for example, an ad identifier, an identifier for the user, and a time stamp for the conversion. The conversion logs 222 can track interactive ad conversions, non-interactive ad conversions, or both.

The mobile device 202 can request and receive interactive ads from the ad system 208 through a network 224. The network 224 can be the Internet, a LAN, a WAN, or any combination thereof. In some implementations, the mobile device 202 can communicate with the ad system 208 through the network 224 using a type of wireless protocol, e.g., IEEE 802.11, WAP and/or Bluetooth. In some other implementations, the mobile device 202 is coupled to the network 224 using one or more physical cables (e.g., when the mobile device 202 is a desktop computer).

In one example, an application on the mobile device 202 can request an ad from the ad system 208. The application can receive an interactive ad identified by the ad presentation module 210. The interactive ad can be presented by the application on the display of the mobile device. The input sensors 218 can receive input from a user and the mobile device 202 can associate the input with the presented interactive ad (e.g., the presented ad 214). For example, an accelerometer can detect movement of the mobile device 202. The mobile device 202 can determine that the movement is input from the user (e.g., and not normal movement of the mobile device 202). The mobile device 202 can determine that the input is associated with the interactive ad and not another process running on the mobile device 202. Embedded ad logic included in the interactive ad can query a mapping of user input patterns to interactive ad actions to identify an action to execute. For example, the embedded ad logic can determine that the input is associated with a zoom action. When the ad logic determines that the pattern is an upward movement of the mobile device 202, the ad logic can zoom in on the ad and/or enlarge the ad. When the ad logic determines that the pattern is a downward movement of the mobile device 202, the ad logic can zoom out the ad, e.g., reduce the ad size or minimize the ad.

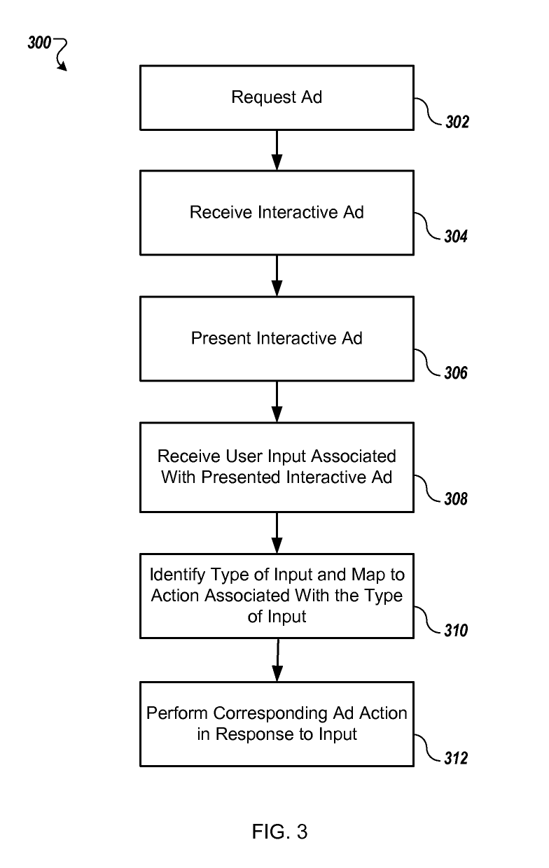

FIG. 3 is a flow chart of an example method 300 for performing an interactive ad action. A mobile device (e.g., the mobile device 202) and parts thereof will be referred to in the following as examples. The method 300 can be performed by one or more other systems in conjunction with or instead of the mobile device.

An ad is requested (302). For example, the mobile device can request an ad from the ad system (e.g., the ad system 208). The mobile device can also request additional content (e.g., a web page or application content) from a publisher contemporaneously with the ad request. Alternatively, the mobile device can request content from a publisher, and the publisher can request the ad from the ad system.

For example, an application (e.g., one of the applications 206) on the mobile device can request content (e.g., an ad) from the ad system. In another example, a web browser (e.g., the web browser 204) can request ads from the ad system for presentation on a web page (e.g., based on ad script in html being loaded into the browser). In another example, ad logic associated with a presented interactive ad can determine that user input indicates a request for an alternative ad to be presented on the mobile device display. The ad logic can request the alternative ad from the ad system.

An interactive ad is received (304). For example, an ad presentation module (e.g., the ad presentation module 210) can identify an interactive ad to serve to the mobile device. The mobile device can receive the interactive ad from the ad system.

In some implementations, the ad system or the publisher can combine the interactive ad with additional content and provide the combined content to the mobile device. Alternatively, the mobile device can receive and combine the interactive ad and the additional content.

The interactive ad is presented (306). For example, the mobile device can present the interactive ad on a display, e.g., a touch screen display. The interactive ad can be presented with additional content requested from the ad system or the publisher. In some implementations, the interactive ad is presented on the display with other content from the mobile device, e.g., with content associated with the application or web browser that requested the ad.

User input associated with the presented interactive ad is received (308). For example, one or more input sensors (e.g., the input sensors 218) can receive input from a user. The mobile device can determine that the received input is associated with the interactive ad.

The mobile device can determine that input received by a touch screen display is associated with the interactive ad. For example, the mobile device can determine where touch input occurred on the display relative to where the ad is located on the display. If the touch input occurred within a specific proximity of the ad location on the display (e.g., within the boundary of the ad or within a specified pixel distance from the ad), the mobile device can associate the touch input with the interactive ad. Thus, touch input outside the specified proximity of the interactive ad can be associated with other actions, for example, scrolling web page content that includes the ad.

In another example, the mobile device can determine that the interactive ad was highlighted (e.g., a box was presented around the interactive ad) when the input sensors received the user input (e.g., from a trackball or keys on the mobile device).

In some implementations, the mobile device determines that user input is not associated with another process running on the mobile device and associates the user input with the interactive ad. For example, the input sensors can detect movement of the mobile device. The mobile device can determine whether an application was waiting for the received input. If the mobile device does not identify an application that was waiting for the received input, the mobile device can associate the movement with ad logic included in the interactive ad.

In some implementations, the mobile device automatically associates user input with the interactive ad. For example, motion sensors can detect movement of the mobile device and the mobile device can send the detected movement to ad logic associated with the interactive ad.

The type of input is identified and mapped to an action associated with the identified type of input (310). For example, ad logic associated with the interactive ad can identify the type of input based on the input sensor that received the input, e.g., touch input, selection of a button, or movement of the mobile device. The ad logic can query a mapping of unique input patterns to actions for the identified type of input in order to identify an ad action or command corresponding to the received input.

For example, the ad logic can determine that the received input was a touch input on the touch screen display. The ad logic can identify the gesture associated with the touch input (e.g., a single or double tap on the display, a circular motion around a portion of the interactive ad, or a swipe in a particular direction across the interactive ad). The ad logic can match the gesture shape and/or the gesture direction to a particular ad action associated with the gesture shape, the gesture direction, or both. For example, a single tap on the interactive ad can launch a landing page associated with the ad in a web browser. In another example, the interactive ad can be presented on a portion of the display that is difficult to interact with (e.g., a small portion of the display). A clockwise circular gesture around the ad can present the ad on the entire display.

In some implementations, the ad logic determines that the received input was movement or orientation of the mobile device in a particular direction. The ad logic can identify an ad action to execute based on a mapping of movement speed, movement direction, and/or orientations to ad actions. For example, upward vertical movement of the mobile device can display an alternative ad. Alternatively, downward vertical movement of the mobile device can hide the ad. Some examples of a mapping of received input patterns to actions are listed below in table 1.

In some implementations, the ad logic identifies the received input as selection of a button on the mobile device or selection of a button presented on a touch screen display of the mobile device. The ad logic can determine an ad action to execute using the received input to query a mapping of inputs to ad actions. For example, selection of a button can open ad and privacy settings for the mobile device (e.g., settings to opt out of ad tracking, disable audio or video ads, turn off looping of video ads, etc.). In some other implementations, users can provide an input allowing the user to provide feedback on the presented ad (e.g., not appropriate or not interested). The feedback can be used by the ad system to fine tune ads for the particular user and/or device.

The corresponding ad action is performed in response to the input (312). For example, the ad logic can execute a command associated with the corresponding ad action. The command can update options associated with the interactive ad or change the presentation of the interactive ad. Alternatively, the command can provide information to other processes in order to carry out the ad action. In some implementations, the ad logic requests information (e.g., the geographical location of the mobile device) from other processes on the mobile device while executing the command.

The ad logic can execute the command immediately after receiving the user input and identifying the ad action. Alternatively, the ad logic can wait a predetermined amount of time before executing the command (e.g., to determine that the user input was not accidental input). In some implementations, the ad logic executes the command in the background without changing content presented on the display until the command has been completely executed (e.g., once a landing page associated with the interactive ad has loaded in a web browser the web browser is presented on the display).

In one example, ad actions can include saving the ad to the mobile device for later review or redemption (e.g., if the ad is a coupon), forwarding the ad to another computing device (e.g., the mobile device of a friend of the user), or managing ads stored in a repository associated with the mobile device (e.g., with a user account). Ad actions can allow the user to “like” the ad, rate or write a review of the ad, or look at user ratings or reviews associated with the ad.

In some implementations, ad actions include presenting a menu of options associated with the interactive ad. The menu can allow a user to configure settings (e.g., audio or video settings) associated with the ad. The menu can also allow a user to save, forward, or redeem an ad. The menu of options can be specific to the presented interactive ad (e.g., and have no effect for other ads presented on the mobile device). Alternatively, the menu can present privacy settings for the mobile device. The ad actions can present additional information about the privacy settings for the specific ad or the mobile device.

In some implementations, ad actions present information about the business, products, or services displayed in the interactive ad. For example, the ad logic can present a listing of the retail locations associated with the advertised business. Specific ad actions can call the business associated with the ad (e.g., the advertiser or the business advertised), or present directions to a geographical location associated with the ad (e.g., directions to an advertised restaurant from the current location of a car navigation system). In another example, the ad logic can send a message to the ad system requesting that ads for a particular business, product, or service not be served to the mobile device (e.g., ads for a product the user is not interested in purchasing).

In some implementations, an ad action opens a landing page associated with the interactive ad in a web browser. For example, selection of an interactive ad presented in a mobile application can launch a web browser on the mobile device. The ad logic can direct the web browser to a web page associated with additional information about the advertised products or services.

In some other implementations, the ad logic can request an alternative ad to display instead of or in addition to the interactive ad. For example, the ad logic can request multiple alternative ads from the ad system. The mobile device can cycle through presentation of the multiple alternative ads received from the ad system.

In some implementations, ad actions can resize, zoom, hide, or move the interactive ad. For example, the ad logic can disable presentation of ads in a particular region of a web page (e.g., the current web page) or an application.

TABLE 1
Example Mapping of Input Patterns to Actions

| Received Input | Ad Action |
|---|---|
| A single tap on a touch screen display | Open a landing page in a web browser |
| A double tap on a touch screen display | Present an expanded view of the ad or a |
| | menu with ad options (e.g., to save or |
| | forward the ad; to call or receive directions to |
| | the advertised business) |
| A swipe from the left to the right of an ad | Present an alternative ad or cycle through |
| on a touch screen display | alternative ads |
| A swipe from the right to the left of an ad | Hide the ad |
| on a touch screen display | |
| A swipe from the right to the left of an | Present advertiser ad and privacy settings or |
| advertisers logo on a touch screen display | advertiser information |
| A swipe from the bottom to the top of an | Present an expanded view of the ad or |
| ad on a touch screen display | additional details about the ad (e.g., reviews) |
| A swipe from the top to the bottom of an | Present additional options relating to the ad |
| ad on a touch screen display | (e.g., video or audio ad settings) |
| A two finger expand swipe of an ad on a | Present an expanded view of the ad |
| touch screen display | |
| A single tap with two fingers | Present a menu to save or forward the ad or |
| concurrently on a touch screen display | to configure ad options |
| A vertical upward movement of the | Zoom in on a displayed or selected ad |
| mobile device | |
| A vertical downward movement of the | Zoom out of a displayed or selected ad or |
| mobile device | hide a displayed or selected ad |
| A (clockwise) circular movement around | Present additional information about the ad |
| an ad on a touch screen display | |
| A counter-clockwise circular movement | Hide the ad |
| around an ad on a touch screen display | |

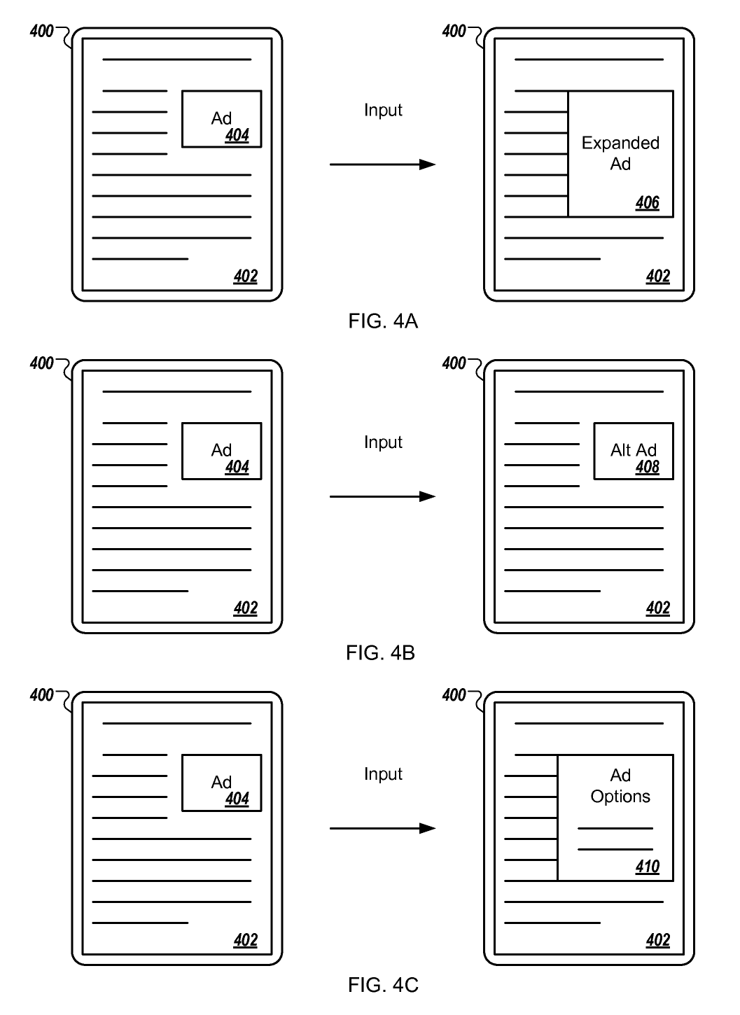

FIGS. 4A-4C show example ad actions made in response to received input. A display 400 of a mobile device (e.g., the mobile device 202) can present content 402 to a user. The content 402 can be a web page, search results, or application content (e.g., for a map application). The content 402 can include an interactive ad 404. Ad logic associated with the interactive ad 404 can receive input associated with the interactive ad 404.

FIG. 4A shows an example of expanding the size of the interactive ad 404 based on input received from a user. The ad logic can query a mapping of user input to ad actions and determine that the ad action associated with the user input is an expand ad action. The ad logic can provide information to the application or web browser presenting the interactive ad 404 indicating the expand ad action and the desired size of the interactive ad 404. The desired size can be specific pixel dimensions, pixels per inch, or a percent of the display 400 to present the interactive ad 404 on. The mobile device can adjust the size of the interactive ad 404 and present an expanded interactive ad 406 on the display 400.

Alternatively, the ad logic can determine that the ad action associated with the user input is a request for an alternative ad, as shown in FIG. 4B. The ad logic can provide a message to the mobile device requesting an alternative ad. The mobile device can request an alternative ad from an ad system (e.g., the ad system 208) and present an alternative ad 408 on the display 400. The alternative ad 408 can be interactive or non-interactive. Alternatively, the mobile device can display an ad that was stored locally on the mobile device or an ad provided by a publisher as the alternative ad 408.

In some implementations, the mapping can associate the user input with an ad privacy options action. For example, the ad logic can determine that the user input indicates a request to display the ad privacy options of the mobile device. As shown in FIG. 4C, the mobile device can present one or more ad privacy options 410 on the display 400. The ad privacy options 410 can be presented with the content 402. Alternatively, the ad privacy options 410 can be presented without the content 402 (e.g., on the entire display 400).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. The computer storage medium can be, or be included in, a computer-readable storage device, a computer-readable storage substrate, a random or serial access memory array or device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving an interactive content item at a mobile device;
presenting the interactive content item on the mobile device, the interactive content item being presented with other content;
receiving a user input associated with the content item, the user input being one of a plurality of available user inputs associated with the content item;
identifying a content item action corresponding to the received user input from among a plurality of content item actions, each associated with a different user input; and
performing, using one or more processors, the identified content item action.

2. The method of claim 1, where the content item is an advertisement.

3. The method of claim 1, further comprising:
associating the user input with the content item including:
detecting a touch input to the mobile device display,
determining a location of the touch input relative to the presented content item, and
associating the user input with the content item if the location is within a specified proximity of the content item.

4. The method of claim 1, further comprising:
associating the user input with the content item including:
detecting movement of the mobile device,
determining whether the movement is associated with another mobile device process, and
associating the user input with the content item if the movement is not associated with another mobile device process.

5. The method of claim 1, where identifying a content item action further comprises:
identifying a pattern associated with the received user input; and
matching the identified pattern to a mapping of patterns to content item actions.

6. The method of claim 1, where performing the content item action includes using embedded logic to execute one or more commands associated with the identified content item action.

7. The method of claim 1, where performing the content item action includes expanding the content item to display additional information about the content item.

8. The method of claim 1, where performing the content item action includes presenting an alternative content item in place of the content item.

9. The method of claim 1, where performing the content item action includes hiding the content item from display.

10. The method of claim 1, where performing the content item action includes presenting content item privacy options.

11. A system comprising:
one or more processors configured to interact with a computer-readable medium in order to perform operations including:
receiving an interactive content item at a mobile device;
presenting the interactive content item on the mobile device, the interactive content item being presented with other content;
receiving a user input associated with the content item, the user input being one of a plurality of available user inputs associated with the content item;
identifying a content item action corresponding to the received user input from among a plurality of content item actions, each associated with a different user input; and
performing, using one or more processors, the identified content item action.

12. The system of claim 11, where the content item is an advertisement.

13. The system of claim 11, further configured to perform operations comprising:
associating the user input with the content item including:
detecting a touch input to the mobile device display,
determining a location of the touch input relative to the presented content item, and
associating the user input with the content item if the location is within a specified proximity of the content item.

14. The system of claim 11, further configured to perform operations comprising:
associating the user input with the content item including:
detecting movement of the mobile device,
determining whether the movement is associated with another mobile device process, and
associating the user input with the content item if the movement is not associated with another mobile device process.

15. The system of claim 11, where identifying a content item action further comprises:
identifying a pattern associated with the received user input; and
matching the identified pattern to a mapping of patterns to content item actions.

16. The system of claim 11, where performing the content item action includes using embedded logic to execute one or more commands associated with the identified content item action.

17. The system of claim 11, where performing the content item action includes expanding the content item to display additional information about the content item.

18. The system of claim 11, where performing the content item action includes presenting an alternative content item in place of the content item.

19. The system of claim 11, where performing the content item action includes hiding the content item from display.

20. The system of claim 11, where performing the content item action includes presenting content item privacy options.

21. A computer storage medium encoded with a computer program, the program comprising instructions that when executed by data processing apparatus cause the data processing apparatus to perform operations comprising:
receiving an interactive content item at a mobile device;
presenting the interactive content item on the mobile device, the interactive content item being presented with other content;
receiving a user input associated with the content item, the user input being one of a plurality of available user inputs associated with the content item;
identifying a content item action corresponding to the received user input from among a plurality of content item actions, each associated with a different user input; and
performing, using one or more processors, the identified content item action.

22. The computer storage medium of claim 21, where the content item is an advertisement.

23. The computer storage medium of claim 21, further comprising instructions that when executed by data processing apparatus cause the data processing apparatus to perform operations comprising:
associating the user input with the content item including:
detecting a touch input to the mobile device display,
determining a location of the touch input relative to the presented content item, and
associating the user input with the content item if the location is within a specified proximity of the content item.

24. The computer storage medium of claim 21, further comprising instructions that when executed by data processing apparatus cause the data processing apparatus to perform operations comprising:
associating the user input with the content item including:
detecting movement of the mobile device,
determining whether the movement is associated with another mobile device process, and
associating the user input with the content item if the movement is not associated with another mobile device process.

25. The computer storage medium of claim 21, where identifying a content item action further comprises:
identifying a pattern associated with the received user input; and
matching the identified pattern to a mapping of patterns to content item actions.

26. The computer storage medium of claim 21, where performing the content item action includes using embedded logic to execute one or more commands associated with the identified content item action.

27. The computer storage medium of claim 21, where performing the content item action includes expanding the content item to display additional information about the content item.

28. The computer storage medium of claim 21, where performing the content item action includes presenting an alternative content item in place of the content item.

29. The computer storage medium of claim 21, where performing the content item action includes hiding the content item from display.

30. The computer storage medium of claim 21, where performing the content item action includes presenting content item privacy options.
